(19) United States
(12) Patent Application Publication
(10) Pub. No.: US 2024/0387827 A1
(43) Pub. Date: Nov. 21, 2024

(54) METHOD FOR MANUFACTURING PARTIALLY FLUORINATED POLYMERS

(71) Applicant: SOLVAY SPECIALTY POLYMERS ITALY S.P.A., Bollate (Milano) (IT)

(72) Inventors: Richard Poirault, Jiangsu (CN); Michele Fiore, Siena (IT); Kai Wu, Jiangsu (CN); Julio A. Abusleme, Saronno (IT)

(73) Assignee: SOLVAY SPECIALTY POLYMERS ITALY S.P.A., Bollate (Milano) (IT)

(21) Appl. No.: 18/556,069

(22) PCT Filed: Apr. 19, 2021
(86) PCT No.: PCT/CN2021/088135

§ 371 Date: Oct. 18, 2023

(51) Int. Cl. H01M 4/62; C08F 8/00; C08F 214/22; H01M 4/02; H01M 4/131

(52) U.S. Cl. CPC H01M 4/623; C08F 8/00; C08F 214/225; H01M 4/131; C08F 2800/10; H01M 2004/028

(57) ABSTRACT

Hydrophilic vinylidene fluoride copolymers and preparation method thereof are provided. The copolymers comprise recurring units derived from hydrophilic monomers. The use of the same for producing articles characterized by improved performances.

### TECHNICAL FIELD

The present invention pertains to hydrophilic vinylidene fluoride copolymers comprising recurring units derived from hydrophilic monomers, to a process for preparing these copolymers and to the use of the same for producing articles characterized by improved performances.

### BACKGROUND ART

Fluoropolymers such as vinylidene fluoride polymers (PVDF) are very useful in a wide range of applications such as automotive materials, pipes and fittings, bearings, linings, and vessels, where good interfacial adhesion between the fluoropolymer and metal surfaces is highly demanded. However, fluoropolymers have very low surface energies and thus poor adhesion with metals.

Surface treatments of fluoropolymers aimed at improving the adhesion to metals are known and established in the art.

Fluoropolymers in the form of sheets, films and shaped articles have been chemically treated, subject to electrical discharges using corona discharge and plasmas, subject to flame treatment, and subject to physical treatment such as chemical adsorbing procedures to improve their adhesion with metals.

Known in the art are also treatments that are applied to fluoropolymer particles to change the chemical functionality of the particle surfaces and thereby change the surface characteristics of said fluoropolymer particles.

As an example, U.S. Pat. No. 6,300,641 discloses a process for irradiating energized ion particles onto the polymeric surface of an article, such as a PVDF surface, in order to decrease the wetting angle of said surface and to increase its adhesive strength. A chemical modification occurs onto the surface of the article since the irradiation is carried out in the presence of a reactive gas that chemically reacts with the surface of the polymer.

Among other surface treatments, JP3269024 discloses a method for producing a surface-modified fluororesin which comprises irradiating the fluororesin with short wavelength ultraviolet rays. Said method is preferably applied to fluororesins in the form of films, but the method can be applied to powders too. With this kind of treatment the surface layer of the fluororesin only can be hydrophilized. In the related art, PVDF has been used as electrode binder of nonaqueous electrolyte secondary batteries. Generally, PVDF homopolymer has poor adhesion to metal. In order to face this problem, several solutions have been proposed. As an example, in WO 2008/129041 it has been demonstrated that including certain recurring units derived from a(meth)acrylic monomer improves the adhesion to metal of PVDF polymers. Depending on the active materials used, higher binding properties between active materials are however still desired.

### SUMMARY OF THE INVENTION

The Applicant perceived that the need still exists for fluoropolymers having improved adhesion to metals.

The Applicant surprisingly found that when certain fluoropolymers comprising recurring units derived from vinylidene fluoride (VDF) and recurring units derived from a hydrophilic monomer are subjected to a low intensity irradiation treatment with ionizing radiation, said fluoropolymers are modified in such a way to obtain fluoropolymers that are much more hydrophilic and are characterized by a huge improvement in the adhesion to metals.

Thus, in a first aspect, the present invention relates to a process for the preparation of a polymer (A), said process comprising a step of irradiating a polymer (F) with an ionizing radiation at a dosage lower than 70 kGy, wherein polymer (F) comprises:
(i) recurring units derived from vinylidene fluoride (VDF), and
(ii) from 0.02% by moles to 5.0% by moles of recurring units derived from at least one hydrophilic monomer [monomer (MA)] of formula (I) here below:

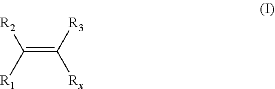

wherein:
R₁, R₂ and R₃, equal to or different from each other, are independently selected from a hydrogen atom and a C₁-C₃ hydrocarbon group, and
R_{X} is a C₁-C₂₀ hydrocarbon moiety comprising at least one functional group selected from a hydroxyl, a carboxyl, an epoxide, an ester and an ether group, the aforementioned percentages by moles being referred to the total moles of recurring units of polymer (F).

With the irradiation process of the present invention a novel vinylidene fluoride (VDF) copolymer [polymer (A)] having a remarkably higher hydrophilicity is obtained.

In another aspect, the present invention thus provides a vinylidene fluoride (VDF) copolymer [polymer (A)] that comprises:
(i) recurring units derived from vinylidene fluoride (VDF);
(ii) from 0.02% by moles to 5.0% by moles of recurring units derived from at least one hydrophilic monomer [monomer (MA)] of formula (I) here below:

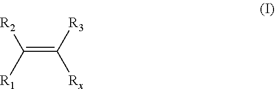

wherein:
R₁, R₂ and R₃, equal to or different from each other, are independently selected from a hydrogen atom and a C₁-C₃ hydrocarbon group, and
R_{X} is a C₁-C₂₀ hydrocarbon moiety comprising at least one functional group selected from a hydroxyl, a carboxyl, an epoxide, an ester and an ether group, the aforementioned percentages by mole being referred to the total moles of recurring units of polymer (A),
   said polymer (A) having a contact angle, according to the method reported in the description below, lower than 73°, preferably lower than 70°.

Polymer (A) as above defined is particularly useful for use as electrode binder of nonaqueous electrolyte secondary batteries.

Thus, in another aspect of the present invention, it is provided an electrode-forming composition [composition (C)] comprising:
a) at least one electrode active material (AM);
b) at least one binder (B), wherein binder (B) comprises at least one vinylidene fluoride (VDF) copolymer [polymer (A)] as above defined; and
c) at least one solvent(S).

### DESCRIPTION OF EMBODIMENTS

By the term “recurring unit derived from vinylidene fluoride” (also generally indicated as vinylidene difluoride 1,1-difluoroethylene, VDF), it is intended to denote a recurring unit of formula CF₂═CH₂.

In an embodiment, monomers (MA) are compounds of formula (I) as above defined wherein R_{X} is a C₁-C₂₀ hydrocarbon moiety comprising at least one carboxyl group.

In another embodiment, monomers (MA) are compounds of formula (Ia):

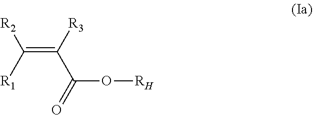

wherein
R₁, R₂ and R₃, equal to or different from each other, are independently selected from a hydrogen atom and a C₁-C₃ hydrocarbon group, and
R_{H} is a hydrogen or a C₁-C₂₀ hydrocarbon moiety comprising at least one carboxyl group.

Non-limitative examples of monomers (MA) of formula (Ia) include, notably:
acrylic acid (AA) and
(meth)acrylic acid,
   and mixtures thereof.

In another embodiment, monomers (MA) are compounds of formula (Ib) here below:

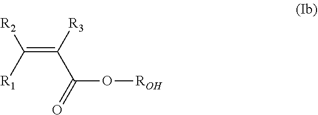

wherein:
R₁, R₂ and R₃, equal to or different from each other, are independently selected from a hydrogen atom and a C₁-C₃ hydrocarbon group, and
R_{OH} is a C₁-C₅ hydrocarbon moiety comprising at least one hydroxyl group.

Non-limitative examples of monomers (MA) of formula (Ib) include, notably, hydroxyethyl(meth)acrylate, hydroxypropyl(meth)acrylate, hydroxyethylhexyl(meth)acrylate.

The monomer (MA) of formula (lb) is even more preferably selected from the followings:
hydroxyethyl acrylate (HEA) of formula:

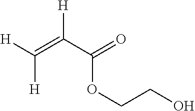

2-hydroxypropyl acrylate (HPA) of either of formulae:

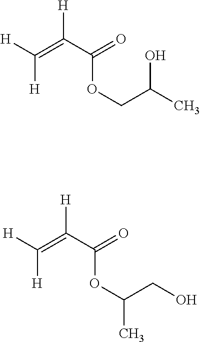

and mixtures thereof.

The monomer (MA) is randomly distributed into said polymer (F). It is essential that in polymer (F) a fraction of at least 40% of monomer (MA) is randomly distributed into said polymer (F).

The expression “fraction of randomly distributed monomer (MA)” is intended to denote the percent ratio between the average number of (MA) monomer sequences (%), said sequences being comprised between two recurring units derived from VDF monomer, and the total average number of (MA) monomer recurring units (%), according to the following formula:

$$Fraction of randomly distribute d units ( MA ) = \frac{average number of ( MA ) sequences ( \% )}{average total number of ( MA ) units ( \% )} \times 100$$

When each of the (MA) recurring units is isolated, that is to say comprised between two recurring units of VDF monomer, the average number of (MA) sequences equal the average total number of (MA) recurring units, so the fraction of randomly distributed units (MA) is 100%: this value corresponds to a perfectly random distribution of (MA) recurring units.

Thus, the larger is the number of isolated (MA) units with respect to the total number of (MA) units, the higher will be the percentage value of fraction of randomly distributed units (MA), as above described.

Determination of total average number of (MA) monomer recurring units in polymer (F) can be performed by any suitable method, NMR being preferred.

The fraction of randomly distributed units (MA) is preferably of at least 50%, more preferably of at least 60%, most preferably of at least 70%.

Polymer (F) comprises preferably at least 0.02% moles, more preferably at least 0.2% moles of recurring units derived from said monomer (MA).

Polymer (F) comprises preferably at most 5.0% moles, more preferably at most 3.0% moles, even more preferably at most 1.5% moles of recurring units derived from monomer (MA).

Excellent results have been obtained using a polymer (F) comprising at least 70% by moles of recurring units derived from VDF.

The polymer (F) can be an elastomer or a semi-crystalline polymer, preferably being a semi-crystalline polymer.

As used herein, the term “semi-crystalline” means a fluoropolymer that has, besides the glass transition temperature Tg, at least one crystalline melting point on DSC analysis. For the purposes of the present invention a semi-crystalline fluoropolymer is hereby intended to denote a fluoropolymer having a heat of fusion determined according to ASTM D 3418 of advantageously at least 0.4 J/g, preferably of at least 0.5 J/g, more preferably of at least 1 J/g.

To the purpose of the invention, the term “elastomer” is intended to designate a true elastomer or a polymer resin serving as a base constituent for obtaining a true elastomer.

True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

Preferably, the intrinsic viscosity of polymer (F), measured in dimethylformamide at 25° C., is comprised between 0.1 l/g and 0.80 l/g, more preferably between 0.15 l/g and 0.45 l/g even more preferably between 0.25 l/g and 0.35 l/g.

The polymer (F) used in the process of the present invention usually has a melting temperature (Tm) comprised in the range from 120 to 200° C.

The melting temperature may be determined from a DSC curve obtained by differential scanning calorimetry (hereinafter, also referred to as DSC). In the case where the DSC curve shows a plurality of melting peaks (endothermic peaks), the melting temperature (Tm) is determined on the basis of the peak having the largest peak area.

The polymer (F) may further comprise recurring units derived from one or more fluorinated comonomers (CF) different from VDF.

By the term “fluorinated comonomer (CF)”, it is hereby intended to denote an ethylenically unsaturated comonomer comprising at least one fluorine atoms.

Non-limitative examples of suitable fluorinated comonomers (CF) include, notably, the followings:
(a) C₂-C₈ fluoro-and/or perfluoroolefins such as tetrafluoroethylene (TFE), hexafluoropropylene (HFP), pentafluoropropylene and hexafluoroisobutylene;
(b) C₂-C₈ hydrogenated monofluoroolefins, such as vinyl fluoride; 1,2-difluoroethylene and trifluoroethylene;
(c) perfluoroalkylethylenes of formula CH₂═CH—R_{f0}, wherein R_{f0} is a C₁-C₆ perfluoroalkyl group;
(d) chloro-and/or bromo-and/or iodo-C₂-C₆ fluoroolefins such as chlorotrifluoroethylene (CTFE).

In one preferred embodiment, polymer (F) is semi-crystalline and comprises from 0.1 to 15.0% by moles, preferably from 0.3 to 5.0% by moles, more preferably from 0.5 to 3.0% by moles of recurring units derived from said fluorinated comonomer (CF).

It is understood that chain ends, defects or other impurity-type moieties might be comprised in the polymer (F) without these impairing its properties.

The polymer (F) more preferably comprises recurring units derived from:
at least 80% by moles, preferably at least 85% by moles of vinylidene fluoride (VDF),
from 0.1% to 3.0% by moles, preferably from 0.15% to 1.5% by moles, more preferably from 0.15% to 1.0% by moles of at least one monomers (MA) of formula (I) as above defined;
optionally from 0.5 to 3.0% by moles of recurring units derived from at least one fluorinated comonomer (CF)
   the aforementioned percentages by moles being referred to the total moles of recurring units of polymer (F).

The polymer (F) may be obtained by polymerization of a VDF monomer, at least one monomer (MA) and optionally at least one comonomer (CF), either in suspension in organic medium, according to the procedures described, for example, in WO 2008129041, or in aqueous emulsion, typically carried out as described in the art (see e.g. U.S. Pat. Nos. 4,016,345, 4,725,644 and 6,479,591).

The polymer (F) is preferably obtained by suspension polymerization.

The procedure for preparing the polymer (F) comprises polymerizing in an aqueous medium in the presence of a radical initiator the vinylidene fluoride (VDF) monomer, and monomer (MA), and optionally comonomer (CF), in a reaction vessel, said process comprising
continuously feeding an aqueous solution comprising monomer (MA); and
maintaining the pressure in said reactor vessel exceeding the critical pressure of the vinylidene fluoride.

During the whole polymerization run, pressure is maintained above critical pressure of vinylidene fluoride. Generally, the pressure is maintained at a value of more than 50 bars, preferably of more than 75 bars, even more preferably of more than 100 bars.

The expressions “continuous feeding” or “continuously feeding” means that slow, small, incremental additions the aqueous solution of monomer (monomer (MA) take place for most of the polymerization, at least until the conversion of 70% by moles of the VDF monomer.

Generally, the process of the invention is carried out at a temperature of at least 20° C., preferably of at least 30° C., more preferably of at least 35° C.

When the polymerization is carried out in suspension, polymer (F) is typically provided in form of powder.

When the polymerization to obtain polymer (F) is carried out in emulsion, polymer (F) is typically provided in the form of an aqueous dispersion (D), which may be used as directly obtained by the emulsion polymerization or after a concentration step. Preferably, the solid content of polymer (F) in dispersion (D) is in the range comprised between 20 and 50% by weight.

Polymer (F) obtained by emulsion polymerization can be isolated from the aqueous dispersion (D) by concentration and/or coagulation of the dispersion and obtained in powder form by subsequent drying.

Polymer (F) in the form of powder may be optionally further extruded to provide polymer (F) in the form of pellets.

Extrusion is suitably carried out in an extruder. Duration of extrusion suitably ranges from few seconds to 3 minutes.

The polymer (F) may be dissolved in any suitable organic solvent to provide a solution (Sol) of polymer (F). Preferably, the solid content of polymer (F) in solution (Sol) is in the range comprised between 2 and 30% by weight.

Non-limitative examples of suitable organic solvents for dissolving polymer (F) are N-methyl-2-pyrrolidone (NMP), N,N-dimethylformamide, N,N-dimethylacetamide, dimethylsulfoxide, hexamethylphosphamide, dioxane, tetrahydrofuran, tetramethylurea, triethyl phosphate, and trimethyl phosphate, aliphatic ketones, cycloaliphatic ketones, cycloaliphatic esters. These organic solvents may be used singly or in mixture of two or more species.

The polymer (F) subjected to the ionizing step in the process of the present invention is preferably in the form of powder.

The step of irradiating a polymer (F) can be carried out with any ionizing radiation, which can thus be an α ray, β ray, γ ray, or electron beam; however, from the perspectives of safety and reactivity, β ray, γ ray and electron beam are preferred.

The irradiation has to be carried out in the presence of oxygen. It may be performed in air.

Known in the art is that irradiation treatments lead to the reduction of the molecular weight of the irradiated polymer by chain scission of the polymer chains, to double bonds along the polymer chain and to the formation of polar groups containing oxygen (Adv Polym Sci (2005) 184:127-211 pages 186-189). The polar groups would be produced mainly by the decomposition of the hydroperoxydes formed by reaction of oxygen and a radical in the backbone of the polymer chain. A later decomposition of the same may lead also to the formation of hydroxyl groups, which explains the increase in hydrophilicity of the polymer.

Irradiation in the presence of oxygen may further favour the formation of said hydroxyl groups are more favoured (Kongop Hwahak (2011), 22 (4), 353-357).

The irradiation step of the process of the present invention is performed in a manner that the absorbed dose of the treated polymer is preferably from 0.1 kGy to 70 kGy, and more preferably from 1 kGy to 40 kGy, even more preferably from 1 kGy to 20 kGy.

The Applicant has surprisingly found that polymer (F) can be modified and rendered hydrophilic under such soft conditions allowing to minimize the damages to the original backbone structure of the polymer (F). In fact, monomer (MA) in polymer (F) remain substantially unchanged in polymer (A) obtained after irradiation, according to NMR and FT-IR analyses. This is mainly due to the low intensity radiation used. Thus, the monomer composition of polymer (A) and polymer (F) is substantially the same. At the same time, the low intensity radiation used in the process of the invention allows polymer (A) to become hydrophilic thanks to the presence of polar groups in the backbone of the polymer chain.

In the present invention, a decrease in the contact angle means the formation of hydrophilic groups on the surface of polymer and the formation of hydrophilic groups would mean a decrease in the contact angle. The term “contact angle” or “water contact angle” used in the present invention is defined as the angle formed between a tangential line of a water drop put on a surface and the surface itself in which the water drop exists.

The irradiation process provoke the modification of polymer (F) with the formation of polar groups, mainly hydroxyl groups in the backbone of the VDF copolymer, which allow obtaining a polymer (A) rendered hydrophilic to water contact angles below 73°.

A decrease in the contact angle means that the water drop is spread widely and thinly onto material surface, whereby the attraction property of the surface to water, that is to say hydrophilicity, increases.

Polymer (A) obtained by the process of the present invention is a novel product.

Thus, in another aspect of the present invention, it is provided a vinylidene fluoride (VDF) copolymer [polymer (A)] that comprises:
(i) recurring units derived from vinylidene fluoride (VDF);
(ii) from 0.02% by moles to 5.0% by moles of recurring units derived from at least one hydrophilic monomer [monomer (MA)] of formula (I) here below:

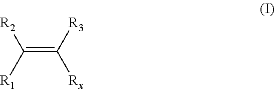

wherein:
R₁, R₂ and R₃, equal to or different from each other, are independently selected from a hydrogen atom and a C₁-C₃ hydrocarbon group, and
R_{X} is a C₁-C₂₀ hydrocarbon moiety comprising at least one functional group selected from a hydroxyl, a carboxyl, an epoxide, an ester and an ether group, the aforementioned percentages by mole being referred to the total moles of recurring units of polymer (A),
   said polymer (A) having a contact angle, according to the method described below, lower than 73°, preferably lower than 70°.

The definitions given above for polymer (F) apply here for polymer (A).

Thus, the monomer (MA) as above defined is randomly distributed into polymer (A). It is essential that in polymer (A) a fraction of at least 40% of monomer (MA) is randomly distributed into said polymer (A).

The fraction of randomly distributed units (MA) in polymer (A) is preferably of at least 50%, more preferably of at least 60%, most preferably of at least 70%.

Polymer (A) comprises preferably at least 0.1% moles, more preferably at least 0.2% moles of recurring units derived from said monomer (MA).

Polymer (A) comprises preferably at most 5.0% moles, more preferably at most 3.0% moles, even more preferably at most 1.5% moles of recurring units derived from monomer (MA).

Excellent results have been obtained with polymer (A) comprising at least 70% by moles of recurring units derived from VDF.

The polymer (A) can be an elastomer or a semi-crystalline polymer, preferably being a semi-crystalline polymer.

Preferably, the intrinsic viscosity of polymer (A), measured in dimethylformamide at 25° C., is comprised between 0.1 l/g and 0.80 l/g, more preferably between 0.15 l/g and 0.45 l/g even more preferably between 0.25 l/g and 0.35 l/g.

The polymer (A) of the present invention usually has a melting temperature (Tm) comprised in the range from 120 to 200° C.

The polymer (A) may further comprise recurring units derived from one or more fluorinated comonomers (CF) different from VDF.

By the term “fluorinated comonomer (CF)”, it is hereby intended to denote an ethylenically unsaturated comonomer comprising at least one fluorine atoms.

Non-limitative examples of suitable fluorinated comonomers (CF) include, notably, the followings:
(a) C₂-C₈ fluoro-and/or perfluoroolefins such as tetrafluoroethylene (TFE), hexafluoropropylene (HFP), pentafluoropropylene and hexafluoroisobutylene;
(b) C₂-C₈ hydrogenated monofluoroolefins, such as vinyl fluoride; 1,2-difluoroethylene and trifluoroethylene;
(c) perfluoroalkylethylenes of formula CH₂═CH—R_{f0}, wherein R_{f0} is a C₁-C₆ perfluoroalkyl group;
(d) chloro-and/or bromo-and/or iodo-C₂-C₆ fluoroolefins such as chlorotrifluoroethylene (CTFE).

In one preferred embodiment, polymer (A) is semi-crystalline and comprises from 0.1 to 10.0% by moles, preferably from 0.3 to 5.0% by moles, more preferably from 0.5 to 3.0% by moles of recurring units derived from said fluorinated comonomer (CF).

It is understood that chain ends, defects or other impurity-type moieties might be comprised in the polymer (A) without these impairing its properties.

The polymer (A) more preferably comprises recurring units derived from:
at least 80% by moles,, preferably at least 85% by moles of vinylidene fluoride (VDF),
from 0.1% to 3.0% by moles, preferably from 0.15% to 1.5% by moles, more preferably from 0.15% to 1.0% by moles of at least one monomers (MA) of formula (I) as above defined;
optionally from 0.5 to 3.0% by moles of recurring units derived from at least one fluorinated comonomer (CF)
   the aforementioned percentages by moles being referred to the total moles of recurring units of polymer (A).

Surface preparation is required for measuring the contact angle of polymer (A), which is in the form of a powder. A film of polymer (A) may be prepared by any known process starting from polymer (A) in the form of powder, such as processing a composition of polymer (A) in a suitable solvent by casting onto an inert support, preferably a glass support, followed by suitable drying to remove the solvent. Water contact angle measurements can then be performed on the side of the film exposed to the substrate.

More in details, water contact angle measurements are suitably performed on polymer films cast from a NMP solution on a glass surface at room temperature using a Contact Angle System OCA20 (DataPhysics Instruments GmbH) instrument. Drops of MilliQ water are automatically deposited on the film surface exposed to the glass substrate during film preparation. The contact angle is determined as an average of 10 measurements.

As said, polymer (A) as above defined is particularly useful for use as electrode binder of nonaqueous electrolyte secondary batteries.

The present invention thus provides an electrode-forming composition [composition (C)] comprising:
a) at least one electrode active material (AM);
b) at least one binder (B), wherein binder (B) comprises at least one vinylidene fluoride (VDF) copolymer [polymer (A)] as above defined; and
c) at least one solvent(S).

The electrode forming compositions (C) of the present invention include one or more electro-active materials (AM). For the purpose of the present invention, the term “electro-active material” is intended to denote a compound which is able to incorporate or insert into its structure and substantially release therefrom alkaline or alkaline-earth metal ions during the charging phase and the discharging phase of an electrochemical device. The electro active material is preferably able to incorporate or insert and release lithium ions.

The nature of the electro active material in the electrode forming composition of the invention depends on whether said composition is used in the manufacture of a positive electrode or a negative electrode.

In the case of forming a positive electrode for a Lithium-ion secondary battery, the electro active compound may comprise a Lithium containing compound.

In one preferred embodiment the lithium containing compound can be a metal chalcogenide of formula LiMQ₂,

In one preferred embodiment the lithium containing compound can be a metal chalcogenide of formula LiMQ₂, wherein M is at least one metal selected from transition metals such as Co, Ni, Fe, Mn, Cr and V or a metal such as Al and a mixture of thereof and Q is a chalcogen such as O or S. Among these, it is preferred to use a lithium-based composite metal oxide of formula LiMO₂, wherein M is the same as defined above. Preferred examples thereof may include LiCoO_{2,} LiNiO₂, LiNiₓCO₁₋ₓO₂ (0<x<1), LiNiₐCo_{b}Al_{c}O₂ (a+b+c=1) and spinel-structured LiMn₂O₄. In another embodiment, still in the case of forming a positive electrode for a Lithium-ion secondary battery, the electro active compound may comprise a lithiated or partially lithiated transition metal oxyanion-based electro-active material of formula M₁M₂ (JO₄)_{f}E_{1-f}, wherein M₁ is lithium, which may be partially substituted by another alkali metal representing less than 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M₂ metals, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂ (JO₄) E1-f electro-active material as defined above is preferably phosphate-based and may have an ordered or modified olivine structure.

More preferably, the electro active compound in the case of forming a positive electrode has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the electro active compound is a phosphate-based electro-active material of formula Li(FeₓMn₁₋ₓ) PO₄ wherein 0≤x≤1, wherein x is preferably 1 (that is to say, lithium iron phosphate of formula LiFePO₄).

In a most preferred embodiment, the electro active material for a positive electrode is selected from lithium-containing complex metal oxides of general formula (III)

LiNiₓM1_{y}M_{2z}Y₂ (III)

wherein M₁ and M₂ are the same or different from each other and are transition metals selected from Co, Fe, Mn, Cr and V, 0.5≤x≤1, wherein y+z=1−x, and Y denotes a chalcogen, preferably selected from O and S.

The electro active material in this embodiment is preferably a compound of formula (III) wherein Y is O. In a further preferred embodiment, M₁ is Mn and M₂ is Co or M₁ is Co and M₂ is Al.

Examples of such active materials include LiNiₓMn_{y}Co_{z}O₂, herein after referred to as NMC, and LiNiₓMn_{y}Co_{z}O₂, herein after referred to as NCA.

Specifically with respect to LiNiₓMn_{y}Co_{z}O₂, varying the content ratio of manganese, nickel, and cobalt can tune the power and energy performance of a battery.

In a particularly preferred embodiment of the present invention, the compound AM is a compound of formula (III) as above defined, wherein 0.5≤x≤1, 0.1≤y≤0.5, and 0≤z≤0.5.

Non limitative examples of suitable electro active materials for positive electrode of formula (III) include, notably:
LiNi_{0.5}Mn_{0.3}Co_{0.2}O₂,
LiNi_{0.6}Mn_{0.2}Co_{0.2}O₂,
LiNi_{0.8}Mn_{0.1}Co_{0.1}O₂,
LiNi_{0.8}Co_{0.15}Al_{0.05}O₂,
LiNi_{0.8}Co_{0.2}O₂,
LiNi_{0.8}Co_{0.15}Al_{0.05}O₂,
LiNi_{0.6}Mn_{0.2}Co_{0.2}O₂
LiNi_{0.8}Mn_{0.1}Co_{0.1}O₂,
LiNi_{0.9}Mn_{0.05}Co0.05O₂.

The compounds:
LiNi_{0.8}Co_{0.15}Al_{0.05}O₂,
LiNi_{0.6}Mn_{0.2}Co_{0.2}O₂,
LiNi_{0.8}Mn_{0.1}Co_{0.1}O₂,
LiNi_{0.9}Mn_{0.05}C_{0.05}O₂,
   are particularly preferred.

In the case of forming a negative electrode for a Lithium-ion secondary battery, the

electro active compounds may preferably comprise one or more carbon-based materials and/or one or more silicon-based materials.

In some embodiments, the carbon-based materials may be selected from graphite, such as natural or artificial graphite, graphene, carbon black and carbon nano tubes (CNT).

These materials may be used alone or as a mixture of two or more thereof.

The carbon-based material is preferably graphite.

The silicon-based compound may be one or more selected from the group consisting of chlorosilane, alkoxysilane, aminosilane, fluoroalkylsilane, silicon, silicon chloride, silicon carbide and silicon oxide. More particularly, the silicon-based compound may be silicon oxide or silicon carbide.

When present in the electro active compounds, the silicon-based compounds are comprised in an amount ranging from 1 to 60% by weight, preferably from 5 to 20% by weight with respect to the total weight of the electro active compounds.

The electrode forming compositions of the invention comprise at least one solvent (S).

The solvent in cathode forming composition comprises one or more organic solvents, preferably polar solvents, examples of which may include: N-methyl-2-pyrrolidone, N,N-dimethylformamide, N,N-dimethylacetamide, dimethylsulfoxide, hexamethylphosphamide, dioxane, tetrahydrofuran, tetramethylurea, triethyl phosphate, and trimethyl phosphate. These organic solvents may be used singly or in mixture of two or more species.

The electrode forming compositions of the present invention typically comprise from 0.5 wt % to 10 wt %, preferably from 0.7 wt % to 5 wt % of polymer (A). The composition also comprises from 80 wt % to 99 wt %, of electro active material(s). All percentages are weight percentages of the total “solids”. For “solids” it is intended “all the ingredients of the electrode forming composition of the invention excluding the solvent”.

In general in the electrode forming compositions of the present invention the solvent is from 10 wt % to 90 wt % of the total amount of the composition. In particular for anode forming composition the solvent is preferably from 25 wt % to 75 wt %, more preferably from 30 wt % to 60 wt % of the total amount of the composition. For cathode forming compositions the solvent is preferably from 5 wt % to 60 wt %, more preferably from 15 wt % to 40 wt % of the total amount of the composition.

The electrode forming compositions of the present invention may further include one or more optional conductive agents in order to improve the conductivity of a resulting electrode made from the composition of the present invention. Conducting agents for batteries are known in the art.

Examples thereof may include: carbonaceous materials, such as carbon black, graphite fine powder carbon nanotubes (CNT), graphene, or fiber, or fine powder or fibers of metals such as nickel or aluminum. The optional conductive agent is preferably carbon black. Carbon black is available, for example, under the brand names, Super P® or Ketjenblack®.

When present, the conductive agent is different from the carbon-based material described above.

The amount of optional conductive agent is preferably from 0 to 30 wt % of the total solids in the electrode forming composition. In particular, for cathode forming compositions the optional conductive agent is typically from 0 wt % to 10 wt %, more preferably from 0 wt % to 5 wt % of the total amount of the solids within the composition.

For anode forming compositions which are free from silicon based electro active compounds the optional conductive agent is typically from 0 wt % to 5 wt %, more preferably from 0 wt % to 2 wt % of the total amount of the solids within the composition, while for anode forming compositions comprising silicon based electro active compounds it has been found to be beneficial to introduce a larger amount of optional conductive agent, typically from 5 wt % to 20 wt % of the total amount of the solids within the composition.

The electrode-forming composition of the invention can be used in a process for the manufacture of an electrode, said process comprising:
(i) providing a metal substrate having at least one surface;
(ii) providing an electrode-forming composition (C) as defined above;
(iii) applying the composition (C) provided in step (ii) onto the at least one surface of the metal substrate provided in step (i), thereby providing an assembly comprising a metal substrate coated with said composition (C) onto the at least one surface;
(iv) drying the assembly provided in step (iii) at a temperature comprised between 50°° C. to 200° C., preferably between 80°° C. to 180° C., for from 5 min up to 48 hours, preferably between 30 min up to 24 hours.

The metal substrate is generally a foil, mesh or net made from a metal, such as copper, aluminium, iron, stainless steel, nickel, titanium or silver.

Under step (iii) of the process of the invention, the electrode forming composition is applied onto at least one surface of the metal substrate typically by any suitable procedures such as casting, printing and roll coating.

Optionally, step (iii) may be repeated, typically one or more times, by applying the electrode forming composition provided in step (ii) onto the assembly provided in step (iv).

The assembly obtained at step (iv) may be further subjected to a compression step, such as a calendaring process, to achieve the target porosity and density of the electrode.

Preferably, the assembly obtained at step (iv) is hot pressed, the temperature during the compression step being comprised from 25° C. and 130° C., preferably being of about 90° C.

Preferred target porosity for the obtained electrode is comprised between 15% and 40%, preferably from 25% and 30%. The porosity of the electrode is calculated as the complementary to unity of the ratio between the measured density and the theoretical density of the electrode, wherein:
the measured density is given by the mass divided by the volume of a circular portion of electrode having diameter equal to 24 mm and a measured thickness; and
the theoretical density of the electrode is calculated as the sum of the product of the densities of the components of the electrode multiplied by their volume ratio in the electrode formulation.

In a further instance, the present invention pertains to the electrode obtainable by the process of the invention.

Therefore the present invention relates to an electrode comprising:
a metal substrate, and
directly adhered onto at least one surface of said metal substrate, at least one layer consisting of a composition comprising:
   (a) at least one vinylidene fluoride (VDF) copolymer [polymer (A)] that comprises:
      (i) recurring units derived from vinylidene fluoride (VDF);
      (ii) recurring units derived from at least one hydrophilic monomer [monomer (MA)] of formula (I) as above defined;
         wherein polymer (A) has a contact angle, according to the method reported in the description, lower than 73°, preferably lower than 70°; and
(b) at least one electro-active material (AM).

The electrode-forming composition (C) of the present invention is particularly suitable for the manufacturing of positive electrodes for electrochemical devices.

The electrode of the invention is particularly suitable for use in electrochemical devices, in particular in secondary batteries, comprising said electrode.

For the purpose of the present invention, the term “secondary battery” is intended to denote a rechargeable battery. The secondary battery of the invention is preferably an alkaline or an alkaline-earth secondary battery. The secondary battery of the invention is more preferably a Lithium-ion secondary battery. An electrochemical device according to the present invention can be prepared by standard methods known to a person skilled in the art.

The main targeted uses of the polymers (A) of the invention, and of compositions (C) comprising said polymers (A), are for the manufacture of binders and electrodes for secondary batteries.

Polymers (A) are also particularly suitable for the preparation of film and membranes, porous membranes in particular such as for example as described in Journal of Membrane Science 178 (2000)13-23. Specially for the preparation of porous membranes for water filtration.

Polymers (A) in dispersion are particularly suitable for the preparation of components for batteries, such as binders for electrodes and layers to be used as separator coating, such as for example for applications described in US201503906 (ARKEMA Inc.), 19 Aug. 2014.

The invention will be now described with reference to the following examples, whose purpose is merely illustrative and not intended to limit the scope of the invention.

### EXPERIMENTAL SECTION

### Raw Materials

Polymer (F-1): VDF-AA (0.9% by moles) polymer having an intrinsic viscosity of 0.292 l/g in DMF at 25° C. and a T₂f of 162° C., obtained as described in WO 2008/129041.

### Determination of Intrinsic Viscosity of Polymer

Intrinsic viscosity (η) [dl/g] was measured using the following equation on the basis of dropping time, at 25° C., of a solution obtained by dissolving the polymer in N,N-dimethylformamide at a concentration of about 0.2 g/dl using a Ubbelhode viscosimeter:

$$[ η ] = \frac{{η}_{sp} + Γ \cdot ln {η}_{r}}{( 1 + Γ ) \cdot c}$$

where c is polymer concentration [g/dl], ηᵣ is the relative viscosity, i.e. the ratio between the dropping time of sample solution and the dropping time of solvent, ηₛₚ is the specific viscosity, i.e. ηᵣ−1, and Γ is an experimental factor, which for polymer (A) corresponds to 3.

### DSC Analysis

DSC analyses were carried out according to ASTM D 3418 standard; the melting point (T_{f2}) was determined at a heating rate of 10° C./min.

### Determination of the Water Contact Angle: Film Preparation and Contact Angle Measurement

### Preparation of the Film of PVDF:

1. Prepare a polymer solution in NMP 10% wt. Dissolution at room temperature, under magnetic stirring overnight.
2. Cast via doctor blade technique the polymer solution onto a glass substrate. Blade height set to reach a final membrane thickness of about 40 μm.
3. Dry the membrane at 90° C. overnight with a dry air flux of 10 l/min.
4. Remove the membrane from the glass substrate.

### Measure of the Water Contact Angle:

Water contact angle measurements were performed on the shiny side of the film (side exposed to the glass substrate during membrane preparation) at room temperature. Using the following Instrument: Contact Angle System OCA20 (DataPhysics Instruments GmbH).
Solvent: MilliQ Water
Measurements setting:
   Drop deposition: Automatic mode
   Drop Volume=2 ml-Speed=0.5 ml/s
   Θ_{M}=average of 10 drops
   Lab. Temperature: 23° C.

### General Preparation of Electrodes with NMC Active Material

Positive electrodes having final composition of 96.5% by weight of NMC, 1.5% by weight of polymer, 2% by weight of conductive additive were prepared as follows.

A first dispersion was prepared by pre-mixing for 10 minutes in a centrifugal mixer 34.7 g of a 6% by weight solution of a polymer in NMP, 133.8 g of NMC, 2.8 g of SC-65 and 8.8 g of NMP.

The mixture was then mixed using a high speed disk impeller at 2000 rpm for 50 minutes. Additional 7.2 g of NMP were subsequently added to the dispersion, which was further mixed with a butterfly type impeller for 20 minutes at 1000 rpm. Positive electrodes were obtained by casting the as obtained compositions on 15 μm thick Al foil with doctor blade and drying the as coated layers in a vacuum oven at temperature of 90° C. for about 50 minutes. The thickness of the dried coating layers was about 110 μm.

### Adhesion Peeling Force between the Aluminium and Electrode Method

180° peeling tests were performed following the setup described in the standard ASTM D903 at a speed of 300 mm/min at 20° C. in order to evaluate the adhesion of the dried coating layer to the Al foil.

### Preparation of Polymer A-1

Polymer (F-1) was treated with e-beam (ß radiation) radiation of 0.6 Mrad. The characteristics of the polymer A-1 are shown in Table 1.

### Preparation of Polymer A-2

Polymer (F-1) was treated with e-beam radiation (ß radiation) of 2.4 Mrad. The characteristics of the polymer A-2 are shown in Table 1.

### Preparation of Polymer A-3

Polymer (F-1) was treated with Y radiation of 0.6 Mrad. The characteristics of the polymer A-3 are shown in Table 1.

TABLE 1

| | | Contact |
|---|---|---|
| | | Angle |
| Polymer | IV [l/g] | [°] |
| F-1 (for comparison) | 0.292 | 78 |
| A-1 | 0.253 | 60 |
| A-2 | 0.175 | 67 |
| A-3 | 0.239 | 69 |

The polymers F-1, A-1, A-2 and A-3 have been used to produce the electrodes according to the procedure described above and the results on peeling adhesion are shown in Table 2.

TABLE 2

| Electrode | | Normalized |
|---|---|---|
| with | Adhesion | Adhesion |
| polymer | [N/m] | [%] |
| F-1 | 117 | 100 |
| A-1 | 202 | 173 |
| A-2 | 137 | 117 |
| A-3 | 181 | 155 |

The results surprisingly show that the electrodes prepared by using polymer A-1, A-2 or A-3 as binder, have a much higher adhesion with even much lower intrinsic viscosity to metal foil than that obtained with polymer F-1, which has not been treated with ionizing radiation such as beta or gamma.

1. A vinylidene fluoride (VDF) copolymer, polymer (A), that comprises:
(i) recurring units derived from vinylidene fluoride (VDF);
(ii) from 0.1% by moles to 5.0% by moles of recurring units derived from at least one hydrophilic monomer, monomer (MA), of formula (I): 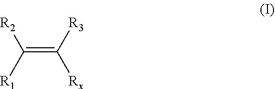
wherein:
R₁, R₂ and R₃, equal to or different from each other, are independently selected from a hydrogen atom and a C₁-C₃ hydrocarbon group, and
Rx is a C₁-C₂₀ hydrocarbon moiety comprising at least one functional group selected from a hydroxyl, a carboxyl, an epoxide, an ester and an ether group, the aforementioned percentages by mole being referred to the total moles of recurring units of polymer (A),
said polymer (A) having a contact angle, according to the method reported in the description, lower than 73°.

2. The polymer (A) according to claim 1, wherein the at least one monomer (MA) is a compound of formula (Ia): 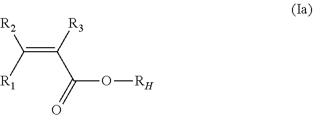
wherein
R₁, R₂ and R₃, equal to or different from each other, are independently selected from a hydrogen atom and a C₁-C₃ hydrocarbon group, and
R_{H} is a hydrogen or a C₁-C₅ hydrocarbon moiety comprising at least one carboxyl group.

3. The polymer (A) according to claim 2, wherein the at least one monomer (MA) of formula (Ia) is selected from the group consisting of acrylic acid (AA),(meth)acrylic acid, and mixtures thereof.

4. The polymer (A) according to claim 1, wherein the at least one monomer (MA) is a compound of formula (Ib): 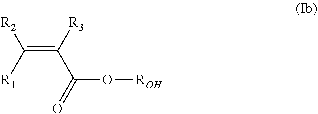
wherein:
R₁, R₂ and R₃, equal to or different from each other, are independently selected from a hydrogen atom and a C₁-C₃ hydrocarbon group, and
R_{OH} is a C₁-C₅ hydrocarbon moiety comprising at least one hydroxyl group.

5. The polymer (A) according to claim 4, wherein the at least one monomer (MA) of formula (Ia) is selected from the group consisting of hydroxyethyl(meth)acrylate, hydroxypropyl(meth)acrylate, and hydroxyethylhexyl(meth)acrylate.

6. The polymer (A) according to claim 1, wherein at least 40% of monomer (MA) is randomly distributed into said polymer (A).

7. The polymer (A) according to claim 1, wherein polymer (A) further comprises recurring units derived from one or more fluorinated comonomers (CF) different from VDF selected from the group consisting of:
(a) C₂-C₈ fluoro-and/or perfluoroolefins;
(b) C₂-C₈ hydrogenated monofluoroolefins;
(c) perfluoroalkylethylenes of formula CH₂═CH—R_{f0}, wherein R_{f0} is a C₁-C₆ perfluoroalkyl group; and
(d) chloro-and/or bromo-and/or iodo-C₂-C₆ fluoroolefins-such as chlorotrifluoroethylene (CTPE).

8. The polymer (A) according to claim 1 wherein polymer (A) is semi-crystalline and comprises from 0.1 to 15.0% by moles of recurring units derived from one or more fluorinated comonomer (CF).

9. A process for the preparation of a polymer (A) according to claim 1, said process comprising a step of irradiating a polymer (F) with an ionizing radiation at a dosage lower than 70 kGy, wherein polymer (F) comprises:
(i) recurring units derived from vinylidene fluoride (VDF), and
(ii) from 0.1% by moles to 5.0% by moles of recurring units derived from at least one hydrophilic monomer, monomer (MA), of formula (I): 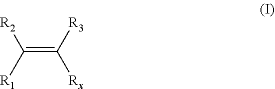
wherein:
R₁, R₂ and R₃, equal to or different from each other, are independently selected from a hydrogen atom and a C₁-C₃ hydrocarbon group, and
R_{X} is a C₁-C₂₀ hydrocarbon moiety comprising at least one functional group selected from a hydroxyl, a carboxyl, an epoxide, an ester and an ether group, the aforementioned percentages by moles being referred to the total moles of recurring units of polymer (F).

10. The process according to claim 9, wherein the step of irradiating a polymer (F) is carried out with an ionizing radiation selected from the group consisting of β ray, γ ray, and electron beam.

11. The process according to claim 9 wherein the irradiation is carried out in the presence of oxygen.

12. The process according to claim 9 wherein the irradiation is carried at a dosage of from 0.1 kGy to 70 kGy.

13. An electrode-forming composition, composition (C), comprising:
a) at least one electrode active material (AM);
b) at least one binder (B), wherein binder (B) comprises at least one vinylidene fluoride (VDF) copolymer, polymer (A), according to claim 1; and
c) at least one solvent(S).

14. An electrode comprising:
a metal substrate, and
directly adhered onto at least one surface of said metal substrate, at least one layer consisting of a composition comprising:
(a) at least one vinylidene fluoride (VDF) copolymer, polymer (A), comprising:
(i) recurring units derived from vinylidene fluoride (VDF);
(ii) recurring units derived from at least one hydrophilic monomer, monomer (MA), of formula (I) 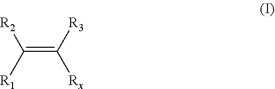
wherein:
R₁, R₂ and R₃, equal to or different from each other, are independently selected from a hydrogen atom and a C₁-C₃ hydrocarbon group, and
R_{X} is a C₁-C₂₀ hydrocarbon moiety comprising at least one functional group selected from a hydroxyl, a carboxyl, an epoxide, an ester and an ether group,
wherein polymer (A) has a contact angle, according to the method reported in the description, lower than 73°; and
(b) at least one electro-active material (AM).

15. The polymer (A) according to claim 1, wherein the polymer (A) has a contact angle of lower than 70°.

16. The polymer (A) according to claim 1, wherein polymer (A) further comprises recurring units derived from one or more fluorinated comonomers (CF) different from VDF selected from the group consisting of:
(a) C₂-C₈ fluoro-and/or perfluoroolefins selected from the group consisting of tetrafluoroethylene (TFE), hexafluoropropylene (HFP), pentafluoropropylene, and hexafluoroisobutylene;
(b) C₂-C₈ hydrogenated monofluoroolefins selected from the group consisting of vinyl fluoride; 1,2-difluoroethylene; and trifluoroethylene;
(c) perfluoroalkylethylenes of formula CH₂═CH—R_{f0}, wherein R_{f0} a C₁-C₆ perfluoroalkyl group; and
(d) chloro-and/or bromo-and/or iodo-C₂-C₆ fluoroolefins selected from the group consisting of chlorotrifluoroethylene (CTFE).

17. The polymer (A) according to claim 1 wherein polymer (A) is semi-crystalline and comprises from 0.3 to 5.0% by moles of recurring units derived from one or more fluorinated comonomer (CF).

18. The process according to claim 9 wherein the irradiation is carried at a dosage of from 1 kGy to 40 kGy.

19. The process according to claim 9 wherein the irradiation is carried at a dosage of from 1 kGy to 20 kGy.

20. The electrode according to claim 14, wherein the polymer (A) has a contact angle of lower than 70°.
